(19) United States
(12) Patent Application Publication
(10) Pub. No.: US 2011/0260088 A1
(43) Pub. Date: Oct. 27, 2011

(54) Ball valve having complex valve seat

(76) Inventor: James A. Cunningham, Lafayette Parish, LA (US)

(21) Appl. No.: 12/799,232

(22) Filed: Apr. 21, 2010

(51) Int. Cl. F16K 5/06

(52) U.S. Cl. 251/315.01

(57) ABSTRACT

A valve includes a valve ball and a complex metal valve seat having a groove for receiving a low pressure seal and a convex ridge on each side of the groove. The valve ball contacts only the low pressure seal at relatively low pressures and contacts the convex ridges at relatively higher pressures to provide a metal-to-metal seal. Typically, the low pressure seal is an O-ring and the volume provided by the groove and its transition to the convex ridges is sufficient to accommodate the volume of the O-ring when the valve ball contacts the convex ridges.

This invention relates to a ball valve and, more particularly, to a ball valve having a complex seat providing a low pressure seal and a separate metal-to-metal high pressure seal with a valve ball.

### BACKGROUND OF THE INVENTION

Typical ball valves include a valve ball operating adjacent a valve seat having a groove therein receiving polymeric seals therein, such as O-rings, to provide a low pressure resilient seal.

As disclosed in U.S. Pat. No. 6,293,517, metal-to-metal seals are very desirable in high pressure valves which are subjected to erosion, such as in kelly valves used to control blow outs in a drill string used for drilling hydrocarbon wells. Although typical metal-to-metal high pressure valves have a valve ball sealing against a concave valve seat, U.S. Pat. No. 6,293,517 discloses a valve ball sealing against a convex valve seat.

The valve disclosed in U.S. Pat. No. 6,293,517 is prone to leak at low pressures because the forces necessary to elastically deform the metal valve ball and metal seat are not created until the valve is exposed to relatively high pressures. Even though low pressure leakage does not detract from the real function of the valve, which is to control blow out pressures, it is disconcerting to those who are not familiar with operation of the valve for it to leak when tested at low pressures because they assume that if it leaks at low pressure it will certainly leak at high pressure.

Disclosures of interest are found in U.S. Pat. Nos. 3,380,708; 3,398,928; 3,455,534; 3,460,802; 3,462,120; 3,497,178; 3,561,727; 3,584,641; 3,814,182; 4,293,038; 4,562,888; 4,700,782; 4,703,807; 5,890,541 and 7,275,591.

### SUMMARY OF THE INVENTION

As disclosed herein, a high pressure ball valve includes a metal valve seat of complex configuration including a groove bounded by a pair of convex ridges. A polymeric seal is positioned in the groove to seal against a valve ball at low pressures. At higher pressures, the valve ball shifts axially and initially collapses the polymeric seal. The valve ball then seals in metal-to-metal fashion against at least one and preferably both convex ridges. In some embodiments, the polymeric seal deforms against the valve ball or, in other words, takes a set so it closely matches the shape of the valve ball.

In important advantage of the disclosed valve is the ridges protect the low pressure seal against damage caused by movement of the valve ball and by the delivery of high pressure against the valve.

It is an object of this invention to provide an improved ball valve having a complex seat providing a low pressure seal and a high pressure metal-to-metal seal with the valve ball.

Another object of this invention is to provide an improved ball valve having a complex seat in which the seat and the valve ball are capable of performing under very high loads without galling.

A more specific object of this invention to provide a valve ball and complex valve seat having a circular groove receiving a low pressure seal bounded by a pair of circular convex ridges which provide a high pressure metal-to-metal seal.

These and other objects and advantages of this invention will become more fully apparent as this description proceeds, reference being made to the accompanying drawings and appended claims.

### BRIEF DESCRIPTION OF THE DRAWINGS

FIG. 1 is a longitudinal cross-sectional view of a valve;

FIG. 2 is an enlarged cross-sectional view of part of the valve of FIG. 1; and

FIG. 3 is a further enlarged cross-sectional view of part of the valve of FIG. 1.

### DETAILED DESCRIPTION

Referring to FIGS. 1-3, a valve 10 is of the type shown in U.S. Pat. Nos. 5,246,203 and 6,293,517, the disclosures of which are incorporated herein by reference. The valve 10 is illustrated as a valve used in a drill string of a rig used to drill hydrocarbon wells into the earth. These valves are called kelly valves for historical reasons even though most modern drilling rigs have top drive units and thus no longer have a rotary table and kelly. Kelly valves are used in conjunction with other equipment to control a blow out. A blow out preventer (not shown) is operated to close rams around the outside of the drill string and thereby prevent uncontrolled flow of oil, gas and/or water on the outside of the drill string. The kelly valve 10 is incorporated in the drill string and is closed to prevent uncontrolled flow of oil, gas and/or water on the inside of the drill string. Thus, kelly valves are designed to hold substantial pressures because they are the tool of last resort to control blow outs. At the present, typical kelly valves have rated pressures between 10,000 and 15,000 psi. A kelly valve must have a large enough valve ball to allow tools and equipment to pass through the center of the valve ball when the valve 10 is open. Thus, a typical kelly valve may have a 4½″ O.D. valve ball and provides an inner passage at least at large as the I.D. of drill pipe comprising the major part of the drill string, typically 3″.

As shown in FIG. 1, a kelly valve 10 includes a housing or conduit 12 having a valve ball 14 captivated therein in any suitable manner, as by a sleeve assembly 16. The valve ball 14 is normally open to allow drilling mud to flow downwardly in the direction of the arrow 18. When it is desired to close the kelly valve 10, an actuator 20 is rotated by a wrench or powered mechanism (not shown) thereby rotating the valve ball 14 about its axis 22 thereby shifting the valve passageway 24 out of registry with the flow path through the housing 12.

The sleeve assembly 16 may be of any suitable type and may preferably be connected to a lower section of the housing or conduit 12 by threads (not shown). The assembly 16 typically includes seals 26 abutting the housing 12 and a rabbit 28. The valve 10 may comprise a lower valve seat 30 positioned in a rabbit 32 provided by the housing 12 and an upper valve seat 34 in the rabbit 28. Suitable seals 36, 38 seal between the seats 30, 34, the housing 12 and the sleeve assembly 16. A spring 40 between the sleeve 16 and the upper seat 34 may be provided to bias the upper seat 34 against the valve ball 14.

The actuator 20 may be of any suitable type, such as shown in U.S. Pat. Nos. 5,246,203 and 6,293,517. One of the peculiarities of kelly valves of the type illustrated is that the valve ball 14 is capable of limited movement perpendicular to the axis 22, as allowed by the spring 40. This limited movement is accommodated by the actuator 20 which typically includes a body 42 having a rib 44 received in a groove or notch 46 provided by the valve ball 14. The actuator 20 is illustrated as including a keeper 48 having means (not shown) retaining the keeper 48 in its passage 50 and thereby retaining the actuator body 42 in operative relation with the valve ball 14. Suitable seals 52, 54 prevent leakage around the actuator 20. Those skilled in the art will recognize the valve 10, as heretofore described, as being typical of modern kelly valves.

At one time, the only important seal of kelly valves was against pressure from below because this is where blow out pressures originate. In other words, at one time, the high pressure seal of a kelly valve was against the upper valve seat 34. Thus, in some embodiments, the complex valve seat disclosed herein is normally the upper valve seat 34. In many situations, however, it is important to test equipment above the kelly valve 10 against blow out pressures. In these situations, the lower valve seat 30 may be similarly configured so the drill string below the kelly valve 10 may be isolated from test pressures above the kelly valve.

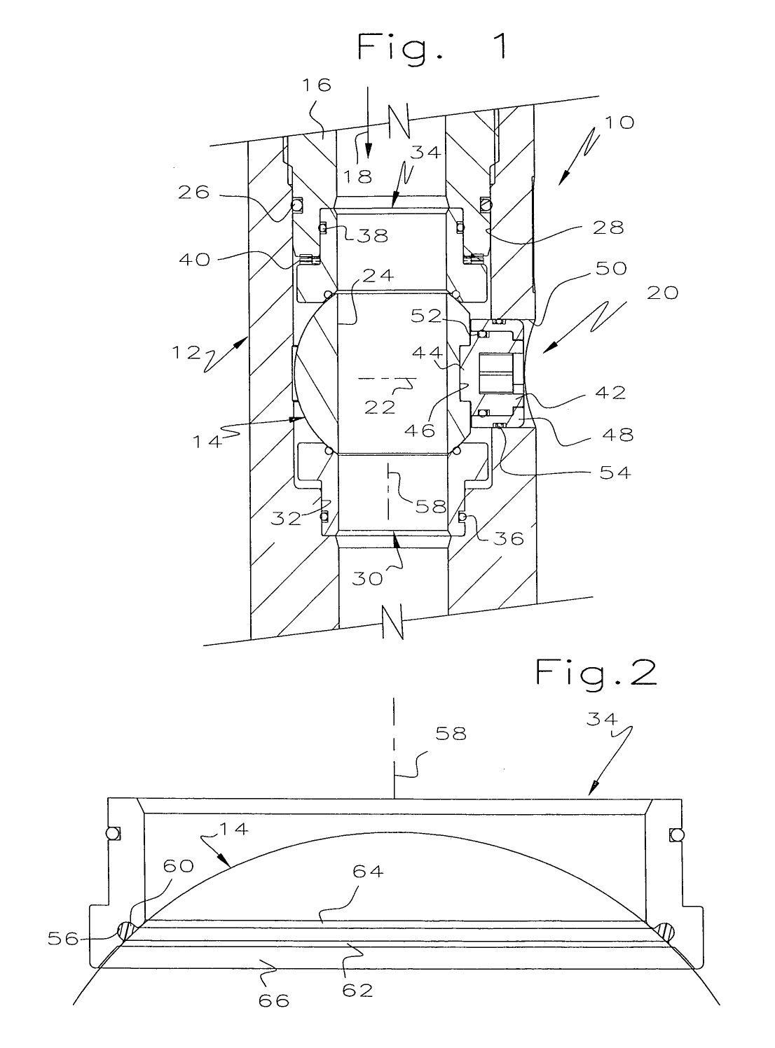

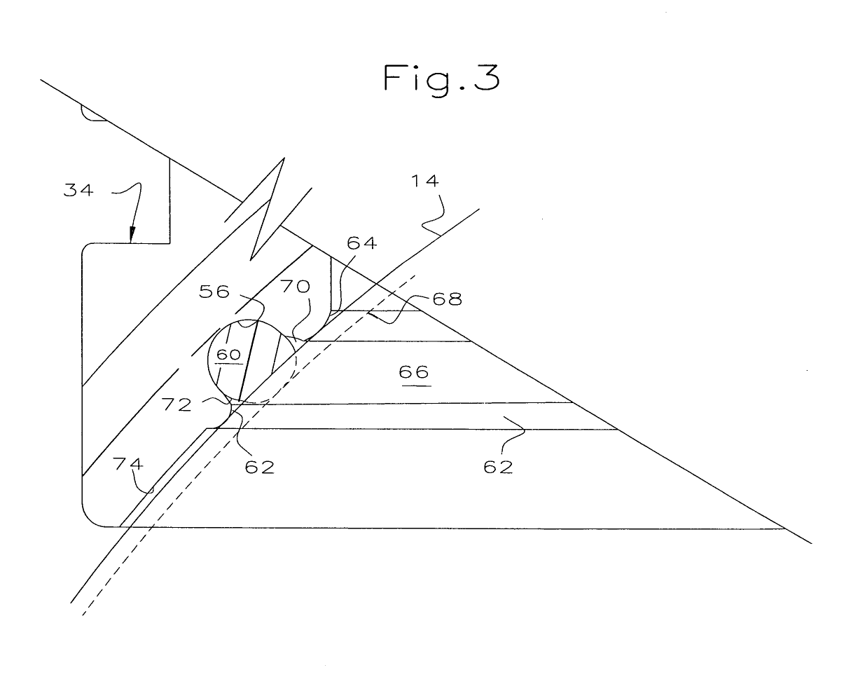

The seat 34 and its relation to the valve ball 14 are shown best in FIGS. 2 and 3, at increasing magnification. The valve seat 34 includes a circular groove 56 extending about an axis 58 of the valve 10 for receiving a seal 60 abutting and sealing against the valve ball 14 at low pressures. The valve seat 34 also includes at least one and preferably two parallel circular convex humps or ridges 62, 64 adjacent and merging with the groove 56 for abutting and sealing against the valve ball 14 at high pressure. The groove 56 may be of any suitable shape and may preferably be of partly circular cross-section opening through a face 66 of the valve seat 34.

The low pressure seal 60 may be of any suitable type and may be a resilient member having the capability of repeatedly deforming and then returning to its original shape. In some embodiments, the low pressure seal 60 is of a material which is partly resilient, meaning that it may permanently deform or take a set when deformed by the valve ball 14 for a significant period of time. This is particularly desirable in many drilling situations where the drilling fluid being circulated carries substantial grit that is prone to erode resilient O-ring type seals. Thus, a preferred seal material has the capability of cold flowing or extruding under continued pressure above some value, of which TEFLON is a prime but not exclusive example.

When the valve 10 is initially assembled, the valve ball 14 is in the dashed line position 68 in FIG. 3, i.e. in contact with and deforming the low pressure seal 60 but out of engagement with the convex ridges 62, 64. The seal 60 may originally be of a round or circular cross-section but, when installed in the valve 10, the inner surface of the seal 60 may deform into the curvature of the valve ball 14. In other words, the seal 60 deforms from a circular cross-section shown partly in dashed lines in FIG. 3 and more-or-less permanently sets into the flattened condition abutting the valve ball 14.

If this were the only seal in the valve 10, the valve 10 would have the characteristic of current valves where, under high pressure, the seal 60 is extruded or cold flowed until pressure escapes from the high pressure side. Instead, pressure from below in FIG. 1, i.e. opposite to the arrow 18, moves the valve ball 14 upwardly to compress the spring 40 so the valve ball 14 and seat 34 bottom out against the sleeve assembly 16. The amount of movement of the valve ball 14 is small and may typically be in the range of 20-50 thousandths of an inch.

Pressure from below also causes the valve ball 14 to move relative to the valve seat 34 and so it abuts and seals metal-to-metal against the convex ridges 62, 64 as shown in solid lines in FIGS. 2 and 3. This prevents high pressure from reaching the low pressure seal 60 as explained more fully hereinafter. Upward movement of the valve ball 14 also causes the seal 60 to be temporarily deformed from the shape shown in FIG. 3 so it fills, or partially fills the complex shaped gaps or creases 70, 72 between the groove 56 and the convex ridges 62, 64.

Thus, the upstream convex ridge 62 provides a metal-to-metal seal against the valve ball 14 and also prevents high pressure from reaching and thereby extruding the low pressure seal 60. In the event there is any leakage past the upstream convex ridge 62 allowing high pressure to reach the seal 60, extrusion or cold flowing of the seal 60 to the point of failure is constrained by the downstream convex ridge 64. The downstream convex ridge 64 thus acts as a metal-to-metal seal against the valve ball 14 but also acts to constrain and thereby protect the seal 60.

There is a dramatic difference between concave and convex valve seats, particularly in the area of contact between the valve ball and the valve seat. The area of contact with a concave seat can vary, depending on the extent of the concavity in the valve seat. The area of contact with a convex seat or with the convex ridges 62, 64 is essentially a line. Thus, the area of contact between the valve ball 14 and the convex ridges 62, 64 is quite small, meaning that the contact pressures are quite large. The convex ridges 62, 64 accordingly elastically deform to provide large enough contact areas to prevent failure of the metal in the ridges 62, 64.

Although the convex ridges 62, 64 are illustrated as being of different radii but they may be of similar or identical radii. As a general rule, it may be preferred to make the radius of any particular ridge as large as feasible to avoid stress concentration in the ridge. In the illustrated embodiment, the upstream ridge 62 is illustrated as being smaller than the downstream ridge 64. In one sense, this is a function of how much metal is machined away to leave the surface or face 74. In some embodiments, it may be preferred to provide the face 74 relatively near the valve ball 14. In such situations, as in the illustrated embodiment, the upstream ridge 62 is typically smaller than the downstream ridge 64 to prevent edges of the slot 46 from marring the ridge 62.

In the illustrated embodiment, the upstream ridge 62 is illustrated as having a smaller radius than the downstream ridge 64. In part, this is because of clearance problems with the valve ball 14 so it may be that the radius of the upstream ridge 62 is considerably smaller than the radius of the groove 56 and/or the downstream ridge 64.

The valve ball 14 and the valve seat 30, 34 may be made of any suitable metal alloys and may preferably be made of steel alloys that are typical in the manufacture of high pressure kelly valves. In a preferred technique, the valve ball 14 and/or either of the valve seats 30, 34 may be made of metals selected to minimize galling or pressure welding problems. Preferably, the ball 14 may be made of stainless steel to avoid corrosion problems although many suitable alloys are feasible.

Although the operating pressures of the valve 10 is dictated by the environment in which it will be used, many embodiments will have low pressure seals 60 that operate to provide a seal at less than 5,000 psi, often substantially less. So, in a typical design, the low pressure seal provides the seal at pressures less than 5,000 psi when the spring 40 allows sufficient movement to allow metal-to-metal sealing between the valve ball 14 and the ridges 62, 64.

There are, of course, many different situations where the valve 10 may be used. In some embodiments, one of the convex ribs 62, 64 might be eliminated. In some embodiments, the larger diameter rib 62 might be eliminated to provide the low pressure seal 60 and a high pressure metal-to-metal seal with only the rib 64. In other embodiments, the smaller diameter rib 64 might be eliminated to provide the low pressure seal 60 with a high pressure metal-to-metal seal with only the rib 62.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I claim:

1. A valve comprising a metal valve ball and a metal valve seat, the valve seat comprising a pair of parallel arcuate convex ridges and a groove between the ridges receiving a low pressure seal therein projecting above the convex ridges in a low pressure condition of the valve, the valve ball being movable from the low pressure position contacting only the low pressure seal and a high pressure position contacting the convex ridges in sealing metal-to-metal relation.

2. The valve of claim 1 wherein part of the groove is a generally circular arc and the low pressure seal is an O-ring.

3. The valve of claim 1 wherein the low pressure seal is a resilient seal capable of repeatedly deforming and then returning to its original shape.

4. The valve of claim 1 wherein the low pressure seal has the capacity to permanently deform against the valve ball upon prolonged contact.

5. The valve of claim 2 wherein the low pressure seal is TEFLON.

6. The valve of claim 1 wherein the groove is a generally circular arc having a diameter and at least one of the convex ridges has a radius of curvature substantially less than the groove diameter.

7. The valve of claim 1 wherein the valve ball has the property of contacting only the low pressure seal at pressures below 5,000 psi.

8. The valve of claim 1 wherein the circular groove and the convex ridges merge to provide creases for receiving deformed portions of the low pressure seal when the valve ball contacts the convex ridges.

9. A valve subject to a source of high pressure from a given direction and comprising a metal valve ball and a metal valve seat, the valve seat comprising a circular convex ridge and a parallel groove next to the ridge receiving a low pressure seal therein projecting above the convex ridge in a low pressure condition of the valve, the valve ball being movable from the low pressure position contacting only the low pressure seal and a high pressure position contacting the convex ridge in sealing metal-to-metal relation.

10. The valve of claim 9 wherein the convex ridge is between the low pressure seal and the source of high pressure.

11. The valve of claim 9 wherein the low pressure seal is between the convex ridge and the source of high pressure.
